(19) United States
(12) Patent Application Publication
(10) Pub. No.: US 2014/0187155 A1
(43) Pub. Date: Jul. 3, 2014

(54) HEARING DEVICE WITH POWER MANAGEMENT AND ASSOCIATED METHOD

(71) Applicants: Peter SIEGUMFELDT, Frederiksberg (DK); Nicholas Paul Beardsell, Frederikssund (GB)

(72) Inventors: Peter SIEGUMFELDT, Frederiksberg (DK); Nicholas Paul Beardsell, Frederikssund (GB)

(21) Appl. No.: 13/791,991

(22) Filed: Mar. 9, 2013

(30) Foreign Application Priority Data
Dec. 27, 2012 (DK) PA 2012 70825
Dec. 27, 2012 (EP) 12193225.5

(51) Int. Cl. H04B 5/00

(52) U.S. Cl. CPC H04B 5/0031
USPC 455/41.1

(57) ABSTRACT

A hearing device includes: a housing; a first antenna; a first wireless communication unit coupled to the first antenna and configured to receive and/or send first data via the first antenna; a near field communication tag comprising a second antenna and configured to receive and/or send second data via the second antenna; and a processing unit coupled to the first wireless communication unit and the near field communication tag; wherein the hearing device is configured to detect a first activation of the near field communication tag and activate the first wireless communication unit upon the detection of the first activation.

### RELATED APPLICATION DATA

This application claims priority to and the benefit of Danish Patent Application No. PA 2012 70825, filed on Dec. 27, 2012, pending, and European Patent Application No. 12193225.5, filed on Dec. 27, 2012, pending. The entire disclosures of both of the above applications are expressly incorporated by reference herein.

### FIELD

The present application relates to a hearing device or hearing aid with improved power management and associated method. In particular, the present application relates to a hearing aid with improved power management to reduce the power consumption during hearing device operation and in particular during hearing device operation with wireless communication.

### BACKGROUND

Wireless communication to and from hearing devices has been increasing in continuation of the developments within wireless communication technology. Typically, wireless communication requires a somewhat tedious and power consuming pairing procedure in order to maintain secure connection management. Further, wireless communication puts a further demand on the limited power resources of the hearing device.

### SUMMARY

Accordingly and despite the known solutions, there is a need for improving power management in a hearing device configured for wireless communication.

Accordingly, a hearing device is provided, the hearing device comprising a housing, a first antenna, and a first wireless communication unit coupled to the first antenna and configured to receive and/or send first data via the first antenna. Further, the hearing device comprises a near field communication tag comprising a second antenna and configured to receive and/or send second data via the second antenna, and a processing unit coupled to the first wireless communication unit and the near field communication tag. The hearing device is configured to detect a first activation of the near field communication tag. The hearing device may be configured to activate the first wireless communication unit upon detection of the first activation.

Also disclosed is a method for operating a hearing device comprising a first antenna, a first wireless communication unit, a near field communication tag comprising a second antenna, and a processing unit coupled to the first wireless communication unit and the near field communication tag. The method comprises detecting a first activation of the near field communication tag by an external unit or an accessory device and activating the first wireless communication unit upon detection of the first activation. The method may comprise receiving and/or transmitting first data on the first antenna, e.g. upon detection of the first activation.

It is an advantage that a hearing device with improved power management is provided.

Further, the hearing device and method enable a more efficient use of battery/power resources by selectively activating radio resources in the hearing device.

A hearing device includes: a housing; a first antenna; a first wireless communication unit coupled to the first antenna and configured to receive and/or send first data via the first antenna; a near field communication tag comprising a second antenna and configured to receive and/or send second data via the second antenna; and a processing unit coupled to the first wireless communication unit and the near field communication tag; wherein the hearing device is configured to detect a first activation of the near field communication tag and activate the first wireless communication unit upon the detection of the first activation.

Optionally, the hearing device is configured to detect a second activation of the near field communication tag after the first activation, and deactivate the first wireless communication unit upon the detection of the second activation.

Optionally, the near field communication tag is configured for sending the second data comprising identification data of the hearing device via the second antenna upon the first activation of the near field communication tag.

Optionally, the near field communication tag comprises a first output pin connected to the processing unit, and wherein the near field communication tag is configured to toggle a first output value on the first output pin between logical “0” and “1” upon each activation of the near field communication tag.

Optionally, the first wireless communication unit is configured to receive and/or send the first data at a first frequency that is anywhere in a range from 800 MHz to 1 GHz and/or from 2.4 GHz to 2.5 GHz.

Optionally, the near field communication tag is configured to receive and/or send the second data at a second frequency that is anywhere in a range from 13 MHz to 14 MHz.

Optionally, the near field communication tag is configured to receive and/or send the second data at a frequency that is anywhere in a range from 13 MHz to 14 MHz.

Optionally, the near field communication tag is configured to receive the second data via the second antenna, the second data comprising audio system data for identification of an audio system, and wherein the hearing device is configured to activate the first wireless communication unit according to the audio system data.

Optionally, the audio system data comprises a network group ID for an audio system, and wherein the hearing device is configured to set a receiver parameter and/or a transmitter parameter of the first wireless communication unit according to the network group ID.

Optionally, the audio system data comprises primary audio system data.

Optionally, the hearing device is configured to receive secondary audio system data via the first antenna upon activation of the first wireless communication unit, and wherein the hearing device is configured to set a receiver parameter and/or a transmitter parameter of the first wireless communication unit according to the secondary audio system data.

Optionally, the hearing device is configured to receive secondary audio system data via the first antenna upon activation of the first wireless communication unit, and wherein the hearing device is configured to set a receiver parameter and/or a transmitter parameter of the first wireless communication unit according to the secondary audio system data.

Optionally, the hearing device is configured to receive audio data from an audio system via the first antenna upon activation of the first wireless communication unit.

A method for operating a hearing device comprising a first antenna, a first wireless communication unit, a near field communication tag comprising a second antenna, and a processing unit coupled to the first wireless communication unit and the near field communication tag, the method includes: detecting a first activation of the near field communication tag by an external unit; activating the first wireless communication unit upon the detection of the first activation; and receiving first data on the first antenna.

Optionally, the method further includes detecting a second activation of the near field communication tag by the external unit after the first activation, and deactivating the first wireless communication unit upon the detection of the second activation.

Optionally, the method further includes sending second data comprising identification data of the hearing device via the second antenna upon the first activation of the near field communication tag.

Optionally, the method further includes receiving second data comprising primary audio system data via the second antenna, wherein the act of receiving the first data on the first antenna is based on the primary audio system data.

Optionally, the primary audio system data comprises a network group ID for an audio system, and wherein the method further comprises setting a receiver parameter of the first wireless communication unit according to the network group ID.

Other and further aspects and features will be evident from reading the following detailed description of the embodiments.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only exemplary embodiments and are not therefore to be considered limiting in the scope of the claims.

FIG. 1 schematically illustrates an exemplary hearing device,

FIG. 2 is a flow diagram of an exemplary method according to some embodiments,

FIG. 3 is a flow diagram of an exemplary method according to some embodiments,

FIG. 4 is a flow diagram of an exemplary method according to some embodiments, and

FIG. 5 is a flow diagram of an exemplary method according to some embodiments.

### DETAILED DESCRIPTION

Various embodiments are described hereinafter with reference to the figures. It should be noted that the figures are not necessarily drawn to scale and that elements of similar structures or functions are represented by like reference numerals throughout the figures. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The hearing device may be a headset or a hearing aid. In a hearing aid, the processing unit is configured to adjust the input signal in order to compensate for hearing loss or impairment of the user.

The hearing device comprises a first antenna coupled to a first wireless communication unit.

The first wireless communication unit is configured for wireless data communication, and in this respect interconnected with the first antenna for emission and/or reception of an electromagnetic field. The wireless communication unit may comprise a transmitter, a receiver, a transmitter-receiver pair, such as a transceiver, a radio unit, etc. The wireless communications unit may be configured for communication using any protocol as known for a person skilled in the art, including Bluetooth, WLAN standards, manufacture specific protocols, such as tailored proximity antenna protocols, such as proprietary protocols, such as low-power wireless communication protocols, etc.

The first wireless communication unit may be configured for receiving and/or sending first data at a first frequency. The first wireless communication unit may be configured to, at least in one or more modes of operation, operate only as a receiver, thus further reducing the power consumption of the hearing device.

The first wireless communication unit may be configured to receive and/or send first data at a first frequency in the range from 800 MHz to 1 GHz and/or from 2.4 GHz to 2.5 GHz.

The hearing device comprises a near field communication tag. The near field communication tag comprises a second antenna and an electrical circuit connected to the second antenna. The electrical circuit may comprise a memory. Identification data (HD_ID) of the hearing device may be stored in a read-only part of the memory. The memory or at least a part thereof may be configured to enable writing of data into the memory with an accessory device upon activation of the near field communication tag. Hereby, an accessory device is able to send data, such as receiver settings of the first wireless communication unit, to the hearing aid with no or reduced battery power consumption. The processing unit may be configured to retrieve data from the memory, for example via one or more data pins of the near field communication tag.

The near field communication tag may be configured to receive and/or send second data at a second frequency in the range from 13 MHz to 14 MHz.

The hearing device may comprise a microphone coupled to the processing unit for conversion of audio into an electrical audio signal that is fed to the processing unit. Further, the hearing device may comprise a receiver coupled to the processing unit for converting the processed audio signal from the processing unit to audio.

The processing unit is configured for detecting a first activation of the near field communication tag. The processing unit is configured to activate the first wireless communication unit upon detection of a first activation. The near field communication tag may be activated by an accessory device, e.g. a mobile phone, smart phone, key card, remote control unit, comprising an NFC device configured to operate as an initiator generating an RF field.

The hearing device and method provide a simple user control of radio resources in the hearing device leading to improved power management in the hearing device. Further, the use of a near field communication tag enables utilizing external power, e.g. from an accessory device, for at least a part of the communication, thus reducing the power requirements to the hearing device.

When the first wireless communication unit is activated, the processing unit outputs a processed audio signal to the receiver. The processed audio signal may be based on the input from the first wireless communication unit and/or the input from the microphone. The receiver converts the processed audio signal from the processing unit into audio.

The hearing device may be configured to detect a second activation of the near field communication tag after the first activation. The hearing device, e.g. the processing unit, may be configured to deactivate the first wireless communication unit upon detection of the second activation.

In an exemplary hearing device, the hearing device may be configured to detect a setup activation of the near field communication tag before the first activation. The near field communication tag may be configured to send identification data of the hearing device to an external unit or accessory device upon the setup activation and/or the first activation. Alternatively, or in combination, the hearing device may be configured to set receiver parameters of the first wireless communication unit after detection of the setup activation and/or the first activation, e.g. according to audio system data received via the second antenna.

Deactivation of the first wireless communication unit may be initiated in several ways. The hearing device, e.g. the processing unit, may be configured to deactivate the first wireless communication unit upon receipt of a termination signal via the first antenna and/or upon end of transmission of first data (for example if no first data has been received for a period of time, e.g. 1 minute). By utilizing the detection of a second activation, the user may be given the ability to deactivate the first wireless communication unit in a simple and easy way.

The processing unit may be configured to send a reset signal to the near field communication tag upon deactivation of the first wireless communication unit.

The near field communication tag of the hearing device may be configured for sending second data comprising identification data of the hearing device via the second antenna upon activation, e.g. setup activation and/or first activation, of the near field communication tag. This allows for an external unit or an accessory device to identify the hearing device, and to adjust transmitter/receiver parameters of the external unit or the accessory device accordingly, which in turn reduces the power consumption in the hearing device.

The near field communication tag may comprise one or more output pins including a first output pin connected to the processing unit. The near field communication tag may be configured to toggle the first output value on the first output pin between logical “0” and “1” upon each activation of the near field communication tag. The one or more output pins may be connected to the output of a counter that is incremented each time the near field communication tag is activated by an external unit or an accessory device.

The processing unit may be configured to control the first wireless communication unit based on the output pin value(s) on the one or more output pins of the near field communication tag.

The processing unit may be configured to activate the first wireless communication unit when the output pin(s) of the near field communication tag has a value indicative of first activation, for example when the first output pin is set to “1” or “0” depending on implementation.

The processing unit may be configured to deactivate the first wireless communication unit when the output pin(s) of the near field communication tag has a value indicative of second activation, for example when the first output pin or a second output pin is set to “1” or “0” depending on implementation.

If a termination signal is received by the first antenna, the first wireless communication unit may be deactivated and induce the first output pin to be set to logical “0”.

The processing unit may be configured to send a reset signal to the near field communication tag upon deactivation of the first wireless communication unit. The near field communication tag may be configured to reset the output pin(s) upon receipt of the reset signal.

The near field communication tag may further be configured to receive second data via the second antenna. The second data may be stored in memory of the near field communication tag and/or transmitted to the processing unit. The second data may comprise primary audio system data for identification of an audio system, wherein the hearing device may be configured to set transmitter/receiver parameters of the first wireless communication unit according to the primary audio system data. A part of the memory such as a first memory may be a read only memory containing an ID number of the hearing device, and a second memory may be a memory for storing, e.g. the network group ID. The processing unit may be configured to access this memory and relay the information to the first wireless communication unit to connect to the desired channel.

The primary audio system data may comprise a network group ID for an audio system, and the hearing device may be configured to set transmitter and/or receiver parameters of the first wireless communication unit according to the network group ID.

The advantage of configuring the near field communication tag to be able to receive second data comprising e.g. a network group ID, is the ability to receive information on a desired audio channel of a plurality of audio channels. Accordingly, an easy and less battery demanding way of setting the first wireless communication unit to receive data from the desired channel is provided.

The hearing device may be configured to receive secondary audio system data via the first antenna upon activation of the first wireless communication unit. The hearing device may be configured to set transmitter and/or receiver parameters of the first wireless communication unit according to the secondary audio system data. In an exemplary hearing device, this feature may be incorporated by activating the first wireless communication unit when a first activation of the near field communication tag is detected. Upon activation, the first wireless communication unit is configured to receive secondary audio system data on a default channel, and the processing unit or the first wireless communication unit is configured to set receiver parameters of the first wireless communication unit accordingly.

The hearing device may further be configured to receive first data as audio data from an audio system via the first antenna upon activation of the first wireless communication unit. When configured to receive audio data, the hearing device may be utilized as a headphone e.g. in a cinema, at a presentation, for a phone or a portable music player.

The method for operating the hearing device comprises detecting a first activation of the near field communication tag by an external unit or an accessory device, and optionally activating the first wireless communication unit upon detection of the first activation.

It may be desirable to be able to deactivate the first wireless communication unit to save power resources, Thus, the method may comprise detecting a second activation of the near field communication tag by an external unit after the first activation, and deactivating the first wireless communication unit upon detection of the second activation. By utilizing the detection of a second activation, the user may be given the ability in an easy way to deactivate the first wireless communication unit.

The method may comprise sending second data, e.g. comprising identification data of the hearing device, via the second antenna upon the first activation of the near field communication tag. This allows for another near field communication device to identify the hearing device, and to setup a more efficient pairing of the two devices via the first antenna. Thus the pairing procedure, e.g. with a smartphone, consume less electrical power compared to conventional procedures of pairing.

The method may comprise receiving second data, e.g. comprising primary audio system data, via the second antenna. Receiving first data on the first antenna may be based on the primary audio system data. The primary audio system data may comprise a network group ID for an audio system, and the method may comprise setting receiver parameters of the first wireless communication unit according to the network group ID.

The advantage of receiving second data comprising e.g. a network group ID, is the ability to receive information regarding a desired channel of a plurality of channels or from a desired transmitter of a plurality of transmitters. Thus, an easy and less battery demanding way of setting the first wireless communication unit to receive data from the desired channel or desired transmitter is provided.

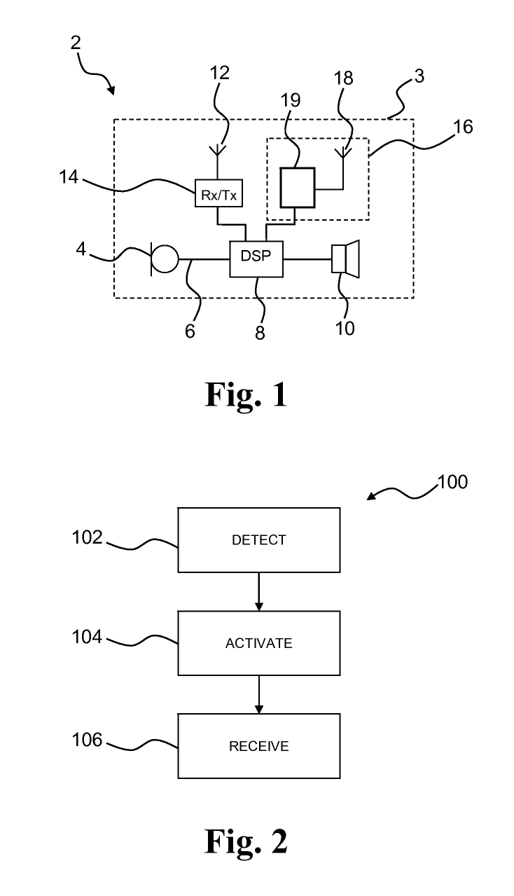

FIG. 1 schematically illustrates an exemplary hearing device. The hearing device 2 comprises a housing 3 accommodating a microphone 4 for converting audio into a converted audio signal 6, and a processing unit 8 connected to the microphone. The processing unit 8 is configured to, at least in a first mode of operation, process the converted audio signal 6. A preprocessing unit and/or an analog-to-digital converter (not shown) may be arranged between the microphone 4 and the processing unit 8. The hearing device comprises a receiver 10 connected to an output of the processing unit 8 for conversion of an output signal of the processing unit into an output audio signal. The hearing device 2 comprises a first antenna 12 and a first wireless communication unit 14 coupled to the first antenna 12 and configured to receive and/or send first data via the first antenna. Further, the hearing device 2 comprises a near field communication tag 16 comprising a second antenna 18 and an electrical circuit 19 connected to the second antenna 18. The near field communication tag 16 is configured to receive and/or send second data via the second antenna 18. The processing unit 8 is coupled/connected to the first wireless communication unit 14, e.g. for receiving and/or sending first data via the first antenna 12. Further, the processing unit 8 is coupled/connected to the near field communication tag 16, e.g. for receiving and/or sending second data via the second antenna 18. The hearing device 2 is configured to detect a first activation of the near field communication tag 16 and activate the first wireless communication unit 14 upon detection of the first activation.

FIG. 2 shows a flow diagram of an exemplary method for operating a hearing device, e.g. in accordance with the hearing device as described herein. The method 100 comprises detecting a first activation of the near field communication tag by an external unit 102, activating the first wireless communication unit upon detection of the first activation 104, and receiving first data on the first antenna 106.

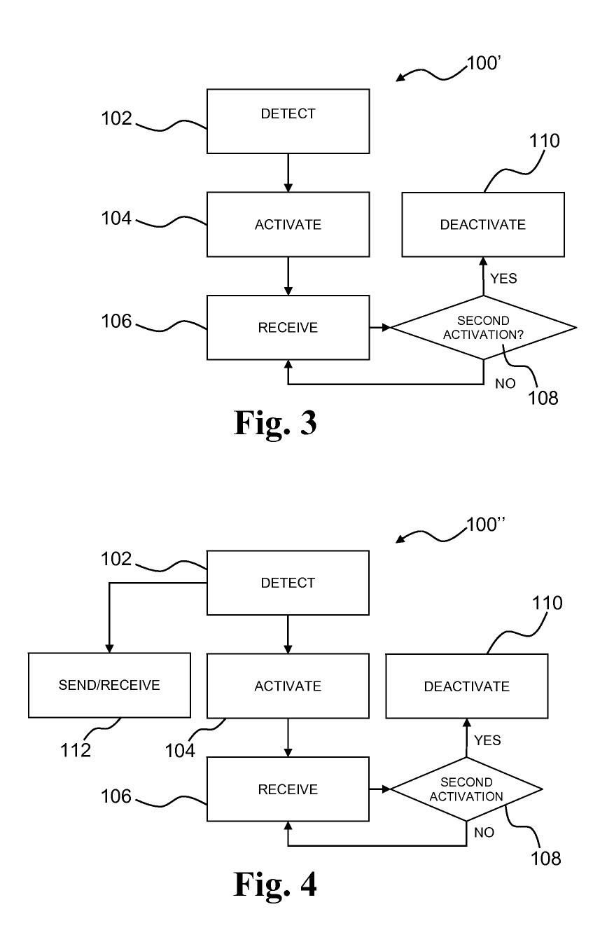

FIG. 3 shows a flow diagram of an exemplary method. The method 100′ comprises detecting 110 a second activation of the near field communication tag by an external unit or an accessory device after the first activation 108, and deactivating the first wireless communication unit upon detection of the second activation. The hearing aid continues to receive first data 106 if present as long as the first wireless communication unit is activated.

FIG. 4 shows a flow diagram of an exemplary method 100″ in accordance with some embodiments. The method 100″ comprises sending and/or receiving 112 second data, e.g. comprising identification data of the hearing device via the second antenna, upon detection 104 of the first activation of the near field communication tag.

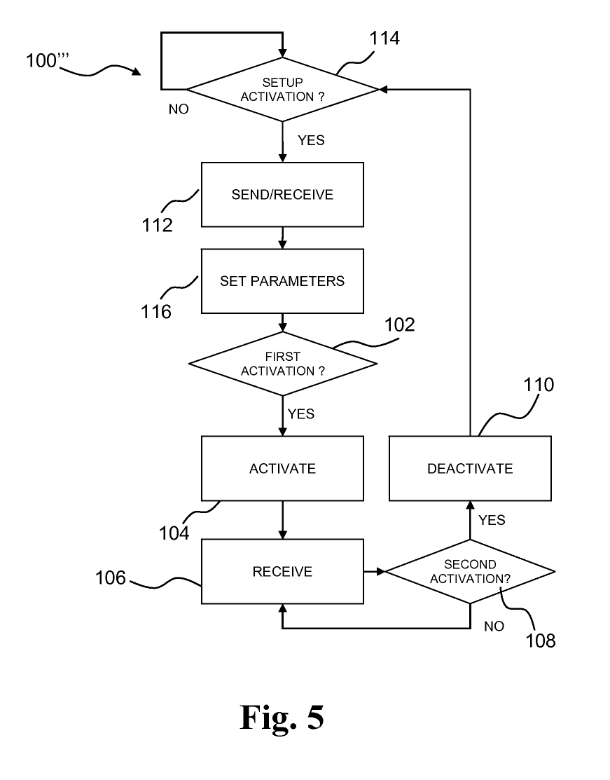

FIG. 5 shows a flow diagram of an exemplary method 100′″ in accordance with some embodiments. The method 100′″ comprises detecting 114 a setup activation of the near field communication tag and optionally receiving/sending 112 second data via the second antenna upon detection of the setup activation. Upon detection 114 of the setup activation, the method proceeds to setting 116 transmitter and/or receiver parameters of the first radio transmitter. Then the method proceeds to detecting 102 a first activation of the near field communication tag. Detecting 108 the second activation may be replaced or supplemented with detecting receipt of a signal indicative of deactivation via the first antenna.

As used in this specification the terms “first”, “second”, etc. (e.g., as in “first activation”, “second activation”, etc.) are used to distinguish one item from another, and are not necessarily terms of order. Thus, “first activation” does not necessarily mean the activation that occurs first.

Although particular embodiments have been shown and described, it will be understood that it is not intended to limit the claimed inventions to the preferred embodiments, and it will be obvious to those skilled in the art that various changes and modifications may be made without departing from the spirit and scope of the claimed inventions. The specification and drawings are, accordingly, to be regarded in an illustrative rather than restrictive sense. The claimed inventions are intended to cover alternatives, modifications, and equivalents.

### LIST OF REFERENCES

2 hearing device
3 housing
4 microphone
6 converted audio signal
8 preprocessing unit
10 receiver
12 first antenna
14 first wireless communication unit
16 near field communication tag
18 second antenna
19 electrical circuit
100, 100′, 100′, 100″, 100′″ method for operating a hearing device
102 detecting a first activation
104 activating the first wireless communication unit
106 receiving first data
108 detecting a second activation
110 deactivating the first wireless communication unit
112 sending and/or receiving second data
114 detecting a setup activation
116 setting receiver and/or transmitter parameters of the first wireless communication unit

1. A hearing aid comprising:
a housing;
a first antenna;
a first wireless communication unit coupled to the first antenna and configured to receive and/or send first data via the first antenna;
a near field communication tag comprising a second antenna and configured to receive and/or send second data via the second antenna; and
a processing unit configured to adjust an input signal in order to compensate for hearing loss or impairment of a user of the hearing aid, the processing unit coupled to the first wireless communication unit and the near field communication tag;
wherein the processing unit is configured to detect a first activation of the near field communication tag and activate the first wireless communication unit upon the detection of the first activation.

2. The hearing aid according to claim 1, wherein the processing unit is configured to detect a second activation of the near field communication tag after the first activation, and deactivate the first wireless communication unit upon the detection of the second activation.

3. The hearing aid according to claim 1, wherein the near field communication tag is configured for sending the second data comprising identification data of the hearing aid via the second antenna upon the first activation of the near field communication tag.

4. The hearing aid according to claim 1, wherein the near field communication tag comprises a first output pin connected to the processing unit, and wherein the near field communication tag is configured to toggle a first output value on the first output pin between logical “0” and “1” upon each activation of the near field communication tag.

5. The hearing aid according to claim 1, wherein the first wireless communication unit is configured to receive and/or send the first data at a first frequency that is anywhere in a range from 800 MHz to 1 GHz and/or from 2.4 GHz to 2.5 GHz.

6. The hearing aid according to claim 5, wherein the near field communication tag is configured to receive and/or send the second data at a second frequency that is anywhere in a range from 13 MHz to 14 MHz.

7. The hearing aid according to claim 1, wherein the near field communication tag is configured to receive and/or send the second data at a frequency that is anywhere in a range from 13 MHz to 14 MHz.

8. The hearing aid according to claim 1, wherein the near field communication tag is configured to receive the second data via the second antenna, the second data comprising audio system data for identification of an audio system, and wherein the hearing aid is configured to activate the first wireless communication unit according to the audio system data.

9. The hearing aid according to claim 8, wherein the audio system data comprises a network group ID for an audio system, and wherein the hearing aid is configured to set a receiver parameter and/or a transmitter parameter of the first wireless communication unit according to the network group ID.

10. The hearing aid according to claim 8, wherein the audio system data comprises primary audio system data.

11. The hearing aid according to claim 10, wherein the hearing aid is configured to receive secondary audio system data via the first antenna upon activation of the first wireless communication unit, and wherein the hearing aid is configured to set a receiver parameter and/or a transmitter parameter of the first wireless communication unit according to the secondary audio system data.

12. The hearing aid according to claim 1, wherein the hearing aid is configured to receive secondary audio system data via the first antenna upon activation of the first wireless communication unit, and wherein the hearing aid is configured to set a receiver parameter and/or a transmitter parameter of the first wireless communication unit according to the secondary audio system data.

13. The hearing aid according to claim 1, wherein the hearing aid is configured to receive audio data from an audio system via the first antenna upon activation of the first wireless communication unit.

14. A method for operating a hearing aid comprising a first antenna, a first wireless communication unit, a near field communication tag comprising a second antenna, and a processing unit configured to adjust an input signal in order to compensate for hearing loss or impairment of a user of the hearing aid, the processing unit coupled to the first wireless communication unit and the near field communication tag, the method comprising:
detecting a first activation of the near field communication tag by an external unit;
activating the first wireless communication unit upon the detection of the first activation; and
receiving first data on the first antenna.

15. The method according to claim 14, further comprising detecting a second activation of the near field communication tag by the external unit after the first activation, and deactivating the first wireless communication unit upon the detection of the second activation.

16. The method according to claim 14, further comprising sending second data comprising identification data of the hearing aid via the second antenna upon the first activation of the near field communication tag.

17. The method according to claim 14, further comprising receiving second data comprising primary audio system data via the second antenna, wherein the act of receiving the first data on the first antenna is based on the primary audio system data.

18. The method according to claim 17, wherein the primary audio system data comprises a network group ID for an audio system, and wherein the method further comprises setting a receiver parameter of the first wireless communication unit according to the network group ID.
